(19) United States
(12) Patent Application Publication
(10) Pub. No.: US 2025/0388108 A1
(43) Pub. Date: Dec. 25, 2025

(54) TRACTION BATTERY CONTROLLER WHICH ADJUSTS FOR CURRENT-DEPENDENT VARIANCE OF BATTERY MODEL PARAMETERS AT LOW TEMPERATURE ENVIRONMENT IN DETECTING BATTERY POWER CAPABILITY

(71) Applicant: FORD GLOBAL TECHNOLOGIES, LLC, Dearborn, MI (US)

(72) Inventors: Xiaohong Nina Duan, Canton, MI (US); Yonghua LI, Ann Arbor, MI (US); Donnell Matthew Washington, Northville, MI (US)

(73) Assignee: Ford Global Technologies, LLC, Dearborn, MI (US)

(21) Appl. No.: 18/750,335

(22) Filed: Jun. 21, 2024

(51) Int. Cl. B60L 53/62; H01M 10/44; H01M 10/46; H02J 7/00

(52) U.S. Cl. CPC B60L 53/62; H01M 10/44; H01M 10/46; H02J 7/00714; B60L 2240/545; B60L 2240/549; H01M 2220/20

(57) ABSTRACT

A system, such as an electrified vehicle, includes a battery, such as a traction battery. The system further includes a controller configured to charge and/or discharge the battery based on a power capability of the battery defined by a value of a parameter of a model of the battery mapped from a value of the parameter that is learned with a battery current of the battery different from a battery current used in calculating the power capability.

### TECHNICAL FIELD

The present disclosure relates to detecting a power capability of a traction battery of an electrified vehicle for use in controlling the operation of the traction battery and/or the vehicle.

### BACKGROUND

An electrified vehicle (EV) includes a traction battery for providing power to a motor to propel the EV. Operating characteristics of the traction battery, such as its power capability (i.e., power limits), charge capacity, and state-of-charge, may be monitored for use in controlling the operation of the traction battery and/or the EV.

As an example, the EV includes a battery management module (BMM) and a control system. Generally, during a discharge operation (e.g., driving of the EV), the BMM estimates operating characteristics of the traction battery, and the control system controls devices/subsystems within the EV by, for example, determining how much power can be drawn from the traction battery using the operating characteristics, inputs from a user, power demand of devices (e.g., motors, air condition system, etc.), and/or among other information. For a charge operation, the BMM provides a charge current/voltage request to the control system, which in return controls the EV (e.g., controls an electric vehicle supply equipment) to charge the traction battery.

### SUMMARY

A system includes a battery and a controller. The controller is configured to charge and/or discharge the battery based on a power capability of the battery defined by a value of a parameter of a model of the battery mapped from a value of the parameter that is learned with a battery current of the battery different from a battery current used in calculating the power capability.

In embodiments, the parameter varies with battery current. Whereby, as the battery current of the battery is different from the battery current used in calculating the power capability, the learned value of the parameter is different than a value of the parameter that would be learned with the battery current used in calculating the power capability.

In embodiments, the mapped value of the parameter is a value of the parameter that would be learned with the battery current of the battery being the battery current used in calculating the power capability.

In embodiments, the controller is further configured to map the mapped value of the parameter from the learned value of the parameter when the battery is in an environment at which the parameter varies with battery current.

In embodiments, the controller is further configured to map the mapped value of the parameter from the learned value of the parameter when a temperature of the battery is less than a predetermined temperature threshold.

In embodiments, the battery current of the battery is lower in magnitude than the battery current used in calculating the power capability.

In embodiments, the model is an equivalent circuit model (ECM) and the parameter is a resistor or other parameters of the ECM. The resistor may be either a resistor R₀ or a resistor R₁. In embodiments, variation of a parameter of the ECM such as the resistor R₀ and the resistor R₁ also can be expressed as a structural function. In this case, the controller may be further configured to detect the power capability of the battery based on the mapped value of the parameter and a value of the parameter such as the resistor R₀ and the resistor R₁ that is mapped from a learned value of a parameter of the structural function.

In embodiments, the learned value of the parameter is learned using a filter, such as a Kalman filter or other types of filters, with the battery current of the battery.

A method includes learning a value of a parameter of a model of a battery with a battery current of the battery. The battery current of the battery is different from a battery current used in calculating a power capability of the battery. The method further includes mapping the learned value of the parameter to a value of the parameter that would be learned with the battery current used in calculating the power capability. The method further includes charging and/or discharging the battery based on a power capability of the battery defined by the mapped value of the parameter.

An electrified vehicle includes a traction battery and a controller. The controller is configured to learn a value of a parameter of a model of the traction battery with a battery current of the traction battery. The controller is further configured to control the traction battery and/or another component of the electrified vehicle based on a power capability of the traction battery defined by a value of the parameter that is mapped from the learned value.

### BRIEF DESCRIPTION OF THE DRAWINGS

FIG. 1 illustrates a block diagram of a battery electric vehicle (BEV);

FIG. 2 illustrates a block diagram of an arrangement for a traction battery controller of the BEV to monitor a traction battery of the BEV;

FIG. 3 illustrates a block diagram of the traction battery controller, the traction battery controller including a power capability estimator for estimating a power capability of the traction battery;

FIG. 4 illustrates a schematic diagram of an equivalent circuit model (ECM) of the traction battery;

FIG. 5A illustrates a graph including plots of the values of the parameters R₀ and R₁ of the ECM versus the current of the traction battery during a low temperature environment of the traction battery for three different state-of-charge (SOC) levels of the traction battery;

FIG. 5B illustrates a graph including plots of the values of the parameters R₀ and R₁ of the ECM versus the current of the traction battery at a given SOC level of the traction battery for two different low temperature environments of the traction battery;

FIG. 6 illustrates a schematic diagram of an ECM of the traction battery in the form of an independent n-RC ECM;

FIG. 7A illustrates a flowchart of calculations carried out by the BECM in detecting the discharge power capability of the traction battery pursuant to a first solution implementation;

FIG. 7B illustrates a flowchart of calculations carried out by the BECM in detecting the charge power capability of the traction battery pursuant to the first solution implementation;

FIG. 8A illustrates a flowchart of calculations carried out by the BECM in detecting the discharge power capability of the traction battery pursuant to a second solution implementation; and

FIG. 8B illustrates a flowchart of calculations carried out by the BECM in detecting the charge power capability of the traction battery pursuant to the second solution implementation.

### DETAILED DESCRIPTION

Detailed embodiments of the present disclosure are disclosed herein; however, it is to be understood that the disclosed embodiments are merely exemplary of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The present disclosure is generally directed to a vehicle system configured to charge/discharge a traction battery based on an estimated power capability of the traction battery. In this regard, the present disclosure deals with issues in calculating the power capability via battery voltages and battery model parameters whose values are different when current passing through the battery is different during same type of temperature and state-of-charge (SOC) conditions. In the vehicle operation, the values of the battery model parameters are learned such as with an Extended-Kalman filter (EKF) (or calculated if parameters are expressed as structural functions) via the current passing through battery at time “t”. However, in the same time, the current used to calculate power capability is different with the current that is passing through the battery. To solve the discrepancy, the battery model parameters learned with EKF in current I, temperature T, and SOC are mapped into the point of current used to calculate power capability (which is I_p=min(I_max, V_min(I_limit))) in same type of temperature and SOC conditions.

The present disclosure proposes two alternative methods for mapping the battery model parameters learned via EKF to the point of power capability calculation. The first method involves using structural function to do mapping when the battery model parameters are represented with structural functions, in which the parameters of structural function are independent on the current, and EKF learning parameters are the parameters of structural function. The second method involves using an iteration process when the battery model parameters are represented with tables.

Significantly, during the battery power capability calculation, the present disclosure considers the difference of the battery model parameters at the same moment under (i) the power capability calculation and (ii) vehicle operation (at where EKF learning is being performed).

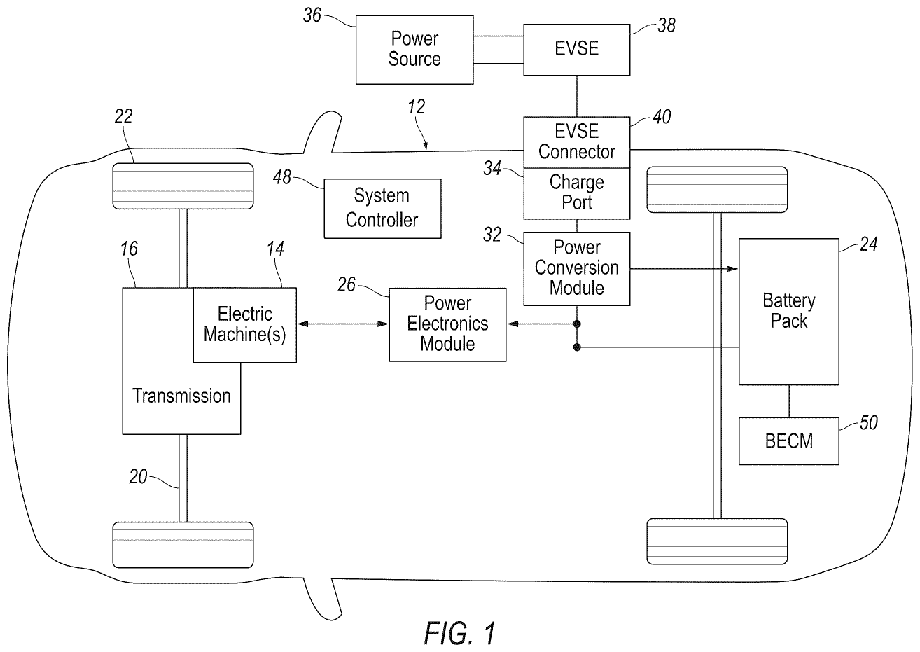

Referring now to FIG. 1, a block diagram of an electrified vehicle (EV) 12 in the form of a battery electric vehicle (BEV) is shown. BEV 12 includes a powertrain having one or more traction motors (“electric machine(s)”) 14, a traction battery (“battery” or “battery pack”) 24, and a power electronics module 26 (e.g., an inverter). In the BEV configuration, traction battery 24 provides all the propulsion power and the vehicle does not have an engine. In other variations, the EV may be a plug-in or regular hybrid electric vehicle (PHEV, HEV) further having an engine.

Traction motor 14 is part of the powertrain of BEV 12 for powering movement of the BEV. In this regard, traction motor 14 is mechanically connected to a transmission 16 of BEV 12. Transmission 16 is mechanically connected to a drive shaft 20 that is mechanically connected to wheels 22 of BEV 12. Traction motor 14 can provide propulsion capability to BEV 12 and can operate as a generator. Traction motor 14 acting as a generator can recover energy that may normally be lost as heat in a friction system of BEV 12.

Traction battery 24 stores electrical energy that can be used by traction motor 14 for propelling BEV 12. Traction battery 24 is a direct current (DC) battery that typically provides a high-voltage (HV) DC output. Traction battery 24 may receive a DC input to be recharged (i.e., charged). Traction battery 24 is electrically connected to power electronics module 26. Traction motor 14 is also electrically connected to power electronics module 26. Power electronics module 26, such as an inverter, provides the ability to bi-directionally transfer energy between traction battery 24 and traction motor 14. For example, traction battery 24 may provide a DC voltage while traction motor 14 may require a three-phase alternating current (AC) current to function. Inverter 26 may convert the DC voltage to a three-phase AC current to operate traction motor 14. In a regenerative mode, inverter 26 may convert three-phase AC current from traction motor 14 acting as a generator to DC voltage compatible with traction battery 24.

In addition to providing electrical energy for propulsion of BEV 12, traction battery 24 may provide electrical energy for use by other electrical systems of the BEV including HV loads such as electric heater and air-conditioner systems, and low-voltage (LV) loads such as an auxiliary battery.

Traction battery 24 is rechargeable by an external power source 36 (e.g., the grid). External power source 36 may be electrically connected to electric vehicle supply equipment (EVSE) 38. EVSE 38 provides circuitry and controls to control and manage the transfer of electrical energy between external power source 36 and BEV 12. External power source 36 may provide DC or AC electric power to EVSE 38. EVSE 38 may have a charge connector 40 for plugging into a charge port 34 of BEV 12. A power conversion module 32 of BEV 12, such as an on-board charger having aa AC/DC converter, converts AC electrical power supplied from EVSE 38 into DC electrical power having proper DC voltage and current levels and provides the DC electrical power to traction battery 24 for recharging the traction battery. Power conversion module 32 transfers DC electrical power supplied from EVSE 38 directly to traction battery 24 for recharging the traction battery. Power conversion module 32 may interface with EVSE 38 to coordinate the delivery of power to traction battery 24.

The various components described above may have one or more associated controllers to control and monitor the operation of the components. The controllers can be microprocessor-based devices. The controllers may communicate via a serial bus (e.g., Controller Area Network (CAN)) or via discrete conductors.

For example, a system controller 48 (“vehicle controller”) is present to coordinate the operation of the various components. Controller 48 includes electronics, software, or both, to perform the necessary control functions for operating BEV 12. Controller 48 may be a combination vehicle system controller and powertrain control module (VSC/PCM). Although controller 48 is shown as a single device, controller 48 may include multiple controllers in the form of multiple hardware devices, or multiple software controllers with one or more hardware devices. In this regard, a reference to a “controller” herein may refer to one or more controllers.

Controller 48 implements a battery energy control module (BECM) 50. BECM 50 is in communication with traction battery 24. BECM 50 is a traction battery controller operable for managing the charging and discharging of traction battery 24 and for monitoring operating characteristics of the traction battery. BECM 50 is operable to implement algorithms to detect (e.g., estimate) the operating characteristics of traction battery 24. BECM 50 (more generally, controller 48) controls the operation and performance of traction battery 24 based on the operating characteristics of the traction battery. The operation and performance of other systems and components of BEV 12 may be controlled by BECM 50 and/or other controllers of the BEV based on the operating characteristics of traction battery 24.

Operating characteristics of traction battery 24 include its charge capacity and its state-of-charge (SOC). The charge capacity of traction battery 24 is indicative of the maximum amount of electrical energy that the traction battery may store. The SOC of traction battery 24 is indicative of a present amount of electrical charge stored in the traction battery. The SOC of traction battery 24 may be represented as a percentage of the maximum amount of electrical charge that may be stored in the traction battery (i.e., as a percentage of the capacity). BECM 50 may output the SOC of traction battery 24 to inform the driver of BEV 12 how much charge remains in the traction battery, similar to a fuel gauge.

Another operating characteristic of traction battery 24 is its power capability. The power capability of traction battery 24 is a measure of the maximum amount of power the traction battery can provide (i.e., discharge) or receive (i.e., charge) for a specified time period. As such, the power capability of traction battery 24 corresponds to discharge and charge power limits which define the amount of electrical power that may be supplied from or received by the traction battery at a given time. These limits can be provided to other vehicle controls, for example, through controller 48, so that the information can be used by systems that may draw power from or provide power to traction battery 24. Vehicle controls are to know how much power traction battery 24 can provide (discharge) or take in (charge) in order to meet the driver demand and to optimize the energy usage. As such, knowing the power capability of traction battery 24 allows electrical loads and sources to be managed such that the power requested is within the limits that the traction battery can handle.

In general, BECM 50 is configured to estimate one or more operating characteristics of traction battery 24 and provide one or more of the operating characteristics to the control system (e.g., controller 48), which controls operation of the traction battery (e.g., control charging/discharging of the traction battery). In an example, during a drive operation, BECM 50 provides operating characteristics such as power limit and/or SOC to the control system which determines how much power to draw from traction battery 24. During a charge operation, BECM 50 notifies the control system of how much power is needed to charge traction battery 24.

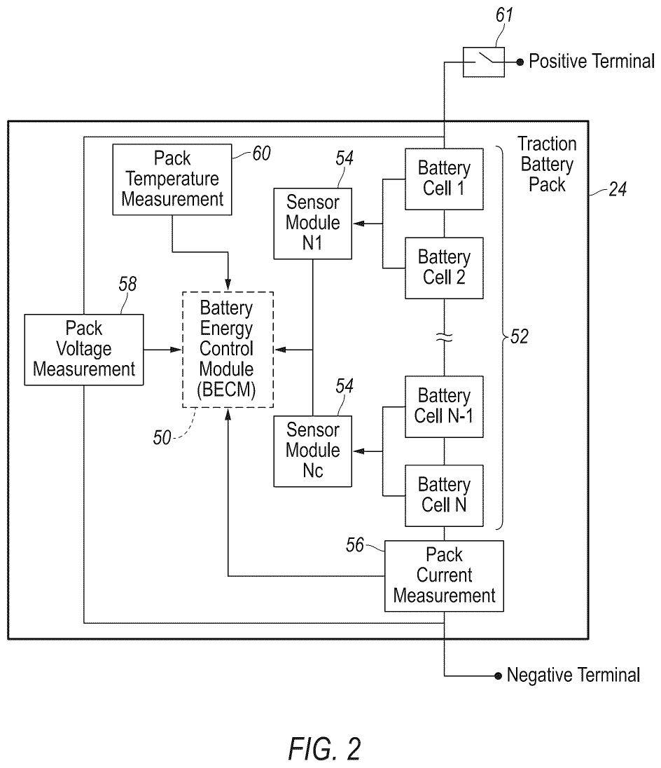

Referring now to FIG. 2, with continual reference to FIG. 1, a block diagram of an arrangement for BECM 50 to monitor traction battery 24 is shown. As indicated in FIG. 2, traction battery 24 is comprised of battery cells 52. Battery cells 52 are physically connected (e.g., connected in series as shown in FIG. 2) between a positive terminal (i.e., a positive power bus) and a negative terminal (i.e., a negative power bus). More generally, traction battery 24 comprises one or more battery cell modules that are electrically connected, and each battery cell module comprises one or more battery cells 52 that are electrically connected. For simplicity of discussion, it is assumed that the battery cell module(s) are connected in series and that battery cells 52 are connected in series.

BECM 50 is operable to monitor pack level (i.e., traction battery level) characteristics of traction battery 24 such as battery current 56, battery voltage 58, and battery temperature 60. Battery current 56 is the current outputted (i.e., discharged) from or inputted (i.e., charged) to traction battery 24. Battery voltage 58 is the terminal voltage of traction battery 24.

BECM 50 is also operable to measure and monitor battery cell level characteristics of battery cells 52 of traction battery 24. For example, terminal voltage, current, and temperature of one or more of battery cells 52 may be measured. BECM 50 may use a battery sensor 54 to measure the battery cell level characteristics. Battery sensor 54 may measure the characteristics of one or multiple battery cells 52. BECM 50 may utilize Nc battery sensors 54 to measure the characteristics of all battery cells 52. Each battery sensor 54 may transfer the measurements to BECM 50 for further processing and coordination. Battery sensor 54 functionality may be incorporated internally to BECM 50.

Traction battery 24 may have one or more temperature sensors such as thermistors in communication with BECM 50 to provide data indicative of the temperature of battery cells 52 of the traction battery for the BECM to monitor the temperature of the traction battery and/or of the battery cells. BEV 12 may further include a temperature sensor to provide data indicative of ambient temperature for BECM 50 to monitor the ambient temperature.

BECM 50 controls the operation and performance of traction battery 24 based on the monitored traction battery and battery cell level characteristics. For instance, BECM 50 may use the monitored characteristics to detect operating characteristics of traction battery 24 (e.g., power capability, the charge capacity, the SOC, etc., of the traction battery) such as for use in controlling the traction battery and/or BEV 12.

As shown in FIG. 2, one or more contactors 61 is provided to inhibit or permit electric current from traveling through the power buses to/from traction battery 24. Specifically, contactors 61 are operable to electrically decouple traction battery 24 from/to a charge/discharge system of BEV 12. The charge/discharge system includes components that either charge traction battery 24 or act as a load to draw electric power from the traction battery. Thus, the charge/discharge system may include inverter 26 and power conversion module 32 among other components. Contactors 61 may be placed in various suitable positions in BEV 12, such as between the positive power bus and inverter 26.

BECM 50 is configured to open or close contactors 61 based on a message/request from controller 48. Controller 48 is configured to detect when BEV 12 is to be turned ON (i.e., key on) or OFF (i.e., key off) based on an activation input (e.g., a user pressing a button associated with activating/deactivating the BEV). When BEV 12 is to be turned ON, controller 48 provides an activation request to BECM 50 to close contactors 61, thereby coupling traction battery 24 to the charge/discharge system. When BEV 12 is to be turned OFF, controller 48 provides a deactivation request to BECM 50 to open contactors 61, thereby decoupling traction battery 24 from the charge/discharge system. In addition, controller 48 is configured to have BECM 50 close contactors 61 by sending the activation request when traction battery 24 is to be charged or discharged. Likewise, controller 48 is configured to have BECM 50 open contactors 61 by sending the deactivation request when traction battery 24 is not to be charged or discharged.

BECM 50 is configured to open contactors 61 when discharge or charge limits are exceeded or about to become exceeded to thereby decouple traction battery 24 from the charge/discharge system. Of course, BECM 50 is configured to operate traction battery 24 so that the traction battery does exceed the discharge and charge limits while the traction battery is coupled to the charge/discharge system.

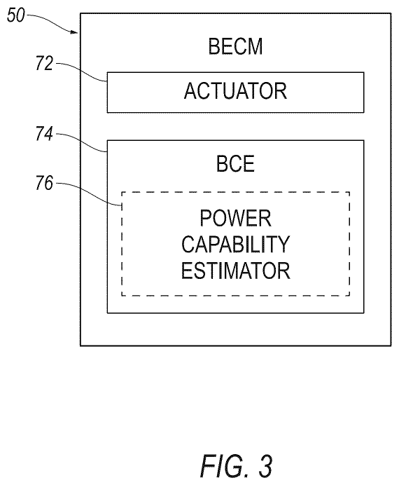

Referring now to FIG. 3, a block diagram of BECM 50 is shown. BECM 50 includes an actuator 72 for operating contactors 61 in the closed/opened positions. BECM 50 further includes a battery characteristics estimator (BCE) 74. BCE 74 is configured to estimate operating characteristics of traction battery 24 including the power capability, the charge capacity, and the SOC of the traction battery. BCE 74 includes a power capability estimator 76 to estimate the power capability of traction battery 24. The operation carried out by power capability estimator 76 (more generally, BECM 50) in estimating the power capability (or power capability prediction (PCP)) of traction battery 24 will now be described.

As known by those of ordinary skill in the art, BECM 50 may measure operating characteristics of traction battery 24, including its power capability, by using an observer, wherein a battery model (i.e., an “Equivalent Circuit Model” (ECM)) is used for construction of the observer, with measurements of battery current, battery terminal voltage, and battery temperature. BECM 50 may estimate values of parameters of the ECM (e.g., resistances and capacitances of circuit elements of the ECM) and values of states of the ECM (e.g., voltages and currents across circuit elements of the ECM) through recursive estimation based on such measurements. For instance, BECM 50 may use some adaptive estimation method, such as a Kalman filter or an extended Kalman filter (EKF) (collectively “Kalman filter” or “EKF”), to estimate the values of the model parameters and model states.

As an overview, a Kalman filter is an algorithm for estimating the internal state of traction battery 24 given the ECM and measurements of battery current, battery terminal voltage, and battery temperature. The input to the ECM is the measured battery current and the output of the ECM is the measured battery terminal voltage. The Kalman filter predicts what it expects to see as the battery terminal voltage given its present internal state estimate and the measured battery current; compares its estimate of the battery terminal voltage to the measured battery terminal voltage; and updates the values of the parameters and states of the ECM accordingly, with the intention of reducing the estimation error of the estimated battery terminal voltage.

As set forth, an accurate model of traction battery 24 enables BECM 50 to properly control the traction battery which directly affects vehicle performance and driving range for a given full charge. ECMs are widely used in electrified vehicle traction battery control systems in order to satisfy real time control system requirements for calculation speed and RAM/ROM usage. Particularly, an n-RC ECM where n=1 or 2 is widely used (an n-RC ECM is a type of ECM having “n” RC circuit elements each including a resistor (“R”) parameter and a capacitor (“C”) parameter; with n=1, a 1-RC ECM includes one such RC circuit element; and with n=2, a 2-RC ECM includes two such RC circuit elements). As indicated, the parameters for the ECM are learned by BECM 50 with an online learning method such a Kalman filter.

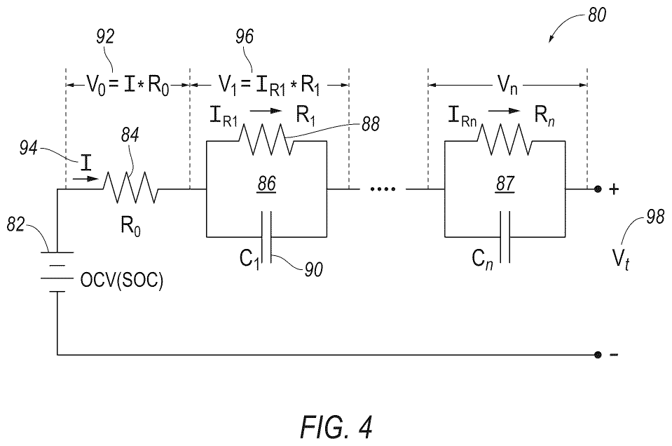

Referring now to FIG. 4, with continual reference to FIG. 1, a schematic diagram of an ECM 80 of traction battery 24 is shown. Per ECM 80, traction battery 24 is modeled as a circuit having in series a voltage source (OCV/(SOC)) 82, a resistor R₀ 84, a first RC pair 86 having a first resistor R₁ 88 and a first capacitor C₁ 90 connected in parallel, and one or more such additional RC pairs 87. As such, ECM 80 is an n-RC ECM where n≥2.

Voltage source 82 represents the open-circuit voltage (OCV) of traction battery 24. The OCV of traction battery 24 depends on the state-of-charge (SOC) of the traction battery and the temperature of the traction battery, and in non-limiting form, traction battery life as well. The OCV of traction battery 24 is not readily measurable. Given an estimate of the OCV of traction battery 24 and the measured temperature, BECM 50 can measure the SOC of the traction battery, particularly when the SOC-OCV relationship is non-flat.

Resistor R₀ 84 represents an internal resistance of traction battery 24. The RC pairs represent the diffusion process of traction battery 24. As such, the diffusion process of traction battery 24 in ECM 80 is described with RC pairs R₁ and C1, . . . , Rₙ and Cₙ. Voltage V₀ 92 is the voltage drop across resistor R₀ 84 due to battery current I 94 which flows across resistor R₀ 84. Voltage V₁ 96 is the voltage drop across first RC pair 86 due to battery current I_{R1} which flows across resistor R₁ 88. A voltage drop is across each additional RC pair 87. Voltage Vt 98 is the voltage across the terminals of traction battery 24 (i.e., the terminal voltage). As indicated, the terminal voltage of traction battery 24 is measurable.

Parameters of ECM 80 include the resistors (i.e., resistor R₀, resistor R₁, and resistor Rₙ) and the capacitors (i.e., capacitor C₁ and capacitor Cₙ). The parameters are to have values whereby the calculated output of ECM 80 in response to a hypothetical given input is representative of the actual output of traction battery 24 (e.g., battery terminal voltage) in response to the actual given input (e.g., battery discharge/charge current). As such, the values of the parameters of ECM 80 have to be accurate so that the ECM accurately models the behavior of traction battery 24.

As indicated, the values of the parameters of the ECM can be learned online by BECM 50 such as with a Kalman filter. Understandably, it is much easier for BECM 50 to learn the values of a few parameters as opposed to learning the values of many parameters. Consequently, as a practical matter, ECM 80 is typically only a 1-RC ECM or a 2-RC ECM.

BECM 50 is operable to measure the power capability, and other operating characteristics, of traction battery 24 using the ECM with the learned values of the parameters. In turn, controller 48 controls the operation of traction battery 24 and/or BEV 12 based on the measured operating characteristics of the traction battery.

However, in low temperature environments, an issue with measuring the power capability of traction battery 24 using the learned values of the parameters is that the learned parameter values may be different than actual parameter values that correspond to a battery current that is used in calculating the power capability. This is an issue because using learned parameter values that are different than the actual parameter values to measure the power capability results in a non-accurate power capability measurement. Conversely, using the actual parameter values to measure the power capability results in an accurate power capability measurement.

The learned parameter values being different than the actual parameter values arises in low temperature environments when the battery current that is measured for use in learning the parameter values (i.e., “the EKF input current” or “the working current”) is different than the battery current used in calculating the power capability. This difference arises because the values of certain parameters, namely the resistor parameters (i.e., R₀ and R₁ of the 1-RC ECM), vary depending on the battery current. The variance of the resistor parameters with battery current is more pronounced in low temperature environments (e.g., temperature≤32° F.) than in non-low temperature environments (e.g., temperature>32° F.), and is relatively significant in low temperature environments. Accordingly, in low temperature environments, the values of the resistor parameters corresponding to a first level of battery current are different than the values of the resistor parameters corresponding to a different second level of battery current. As a result, the resistor parameter values that are learned using the working current (i.e., a first level of battery current) will be different than the actual resistor parameter values that correspond to the battery current used in calculating the power capability (i.e., a second level of battery current). Thus, the power capability measured using the learned parameter values will not be accurate of the actual power capability due to the learned resistor parameter values being different from the actual resistor parameter values.

Embodiments of the present disclosure, which recognize the issue involving the relatively pronounced variance of the resistor parameters of the ECM with battery current in low temperature environments, resolve this issue by mapping the learned resistor parameter values to the actual resistor parameter values (i.e., converting the learned resistor parameter values into the actual resistor parameter values). In effect, the actual resistor parameter values, mapped from the resistor parameter values that are learned using the working current, are resistor parameter values that would be learned from using the battery current used in calculating the power capability. The actual resistor parameter values are then used to measure the power capability of traction battery 24 thereby resulting in an accurate power capability measurement.

Conventional power capability estimation methods do not consider the property of ECM parameters being dependent on battery current. Neglecting the factor that learned parameter values depend on the battery current during the EKF learning process contributes to an estimated power capability error in low temperature. In accordance with embodiments of the present disclosure, BECM 50 adjusts for the current-dependent variance of ECM parameters at low temperature environment in detecting (i.e., measuring) the power capability of traction battery 24. That is, in detecting the power capability of traction battery 24, BECM 50 includes the factor that ECM parameters are dependent on the battery working current in low temperature environments.

For the power capability estimation based on the ECM, for example the discharge case of the 1-RC model, the battery current at time ta seconds after current time t is determined by:

$$i = \frac{OCV - {V}_{t} - {V}_{1} {e}^{- \frac{{t}_{d}}{{τ}_{1}}}}{{R}_{0} + {R}_{1} ( 1 - {e}^{- \frac{{t}_{d}}{{τ}_{1}}} )} \qquad ( 1 )$$

The battery current (i) is denoted as “positive” when it is a discharge current (i.e., flowing out) of traction battery 24.

In the discharge case, the maximum discharge current (i_max) limited by the minimum voltage (Vₜₘᵢₙ) is determined via:

$${i}_{max} = \frac{OCV - {V}_{tmin} - {V}_{1} {e}^{- \frac{{t}_{d}}{{τ}_{1}}}}{{R}_{0} + {R}_{1} ( 1 - {e}^{- \frac{{t}_{d}}{{τ}_{1}}} )} \qquad ( 2 )$$

The minimum voltage under the battery allowed maximum current (i_{dislim}) is determined via:

$${V}_{t} dis = OCV - [ {V}_{1} {e}^{- \frac{{t}_{d}}{{τ}_{1}}} ] - {i}_{dislim} * [ {R}_{0} + {R}_{1} ( 1 - {e}^{- \frac{{t}_{d}}{{τ}_{1}}} ) ] \qquad ( 3 )$$

The discharge power capability at time t_{d} seconds after current time t is determined via:

$${P}_{{cap}_{dis}} ( t ) = \{ \begin{matrix}{i}_{max * {V}_{tmin}} & if {i}_{max < {i}_{dislim}} \\ {i}_{dislim} * {V}_{t} dis & Otherwise\end{matrix} \qquad ( 4 )$$

The selected parameters of R₀, R₁, and τ₁ used by battery power estimation are states in space equations such as:

$$[ \begin{matrix}\frac{dSOC ( t )}{dt} \\ \frac{{dV}_{1} ( t )}{dt} \\ \frac{{dR}_{0} ( t )}{dt} \\ \frac{{dR}_{1} ( t )}{dt} \\ \frac{d {τ}_{1} ( t )}{dt}\end{matrix} ] = [ \begin{matrix}0 & 0 & 0 & 0 & 0 \\ 0 & - \frac{1}{{τ}_{1}} & 0 & 0 & 0 \\ 0 & 0 & 0 & 0 & 0 \\ 0 & 0 & 0 & 0 & 0 \\ 0 & 0 & 0 & 0 & 0\end{matrix} ] [ \begin{matrix}SOC \\ {V}_{1} \\ {R}_{0} \\ {R}_{1} \\ {τ}_{1}\end{matrix} ] + [ \begin{matrix}- \frac{1}{Q} \\ \frac{{R}_{1}}{{τ}_{1}} \\ 0 \\ 0 \\ 0\end{matrix} ] * I ( t ) + w ( t ) \qquad ( 5 )$$

$$V ( t ) = OCV ( t ) - {R}_{0} * I ( t ) - {V}_{1} ( t ) + μ ( t ) \qquad ( 6 a )$$

$$V ( t ) = f ( SOC ( t ) ) - {R}_{0} * I ( t ) - {V}_{1} ( t ) + μ ( t ) \qquad ( 6 b )$$

The state variables in the above state functions are learned online with EKF formulation, through some well-established procedure.

The ECM as described above works properly when traction battery 24 is operating at room temperature or above. The battery power capability, which is derived with the estimated parameters and states, can achieve satisfactory accuracy within that temperature range as parameters R₀ and R₁ depend weakly on battery current within that temperature range.

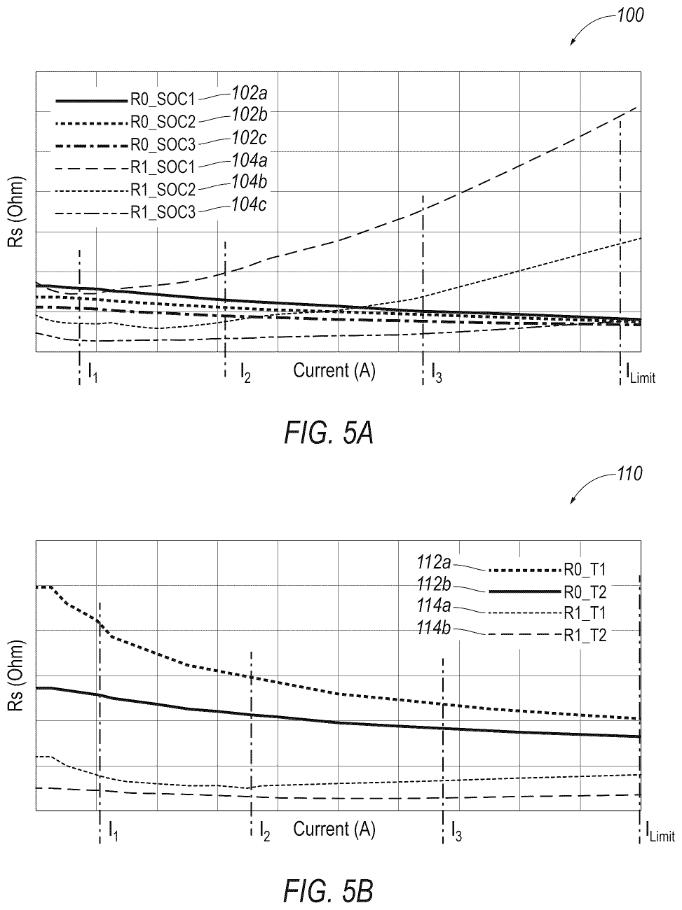

However, in the lower temperature range, the parameters R₀ and R₁ vary more pronounced with battery current, as shown in FIGS. 5A and 5B. In this regard, FIG. 5A illustrates a graph 100 including plots 102a, 102b, 102c of the value of the parameter R₀ and plots 104a, 104b, 104c of the value of the parameter R₁ versus the battery current during a low temperature environment of traction battery 24 for three different SOC levels (SOC1<SOC3). As shown in FIG. 5A, in the low temperature environment, in general, the values of the parameters R₀ and R₁ change as the battery current changes. Particularly, the value of the parameter R₀ decreases as the battery current increases whereas the value of the parameter R₁ increases as the battery current increases. FIG. 5B illustrates a graph 110 including plots 112a, 112b of the value of the parameter R₀ and plots 114a, 114b of the value of the parameter R₁ versus the battery current at a given SOC level for two different low temperature environments of traction battery 24 (T1<T2). As shown in FIG. 5B, with the same SOC and in a low temperature region, the values of the parameters R₀ and R₁ decrease as the current increases.

In further detail, the parameters learned by BECM 50 are related with battery present state of temperature, SOC, and current. Changes in the temperature and SOC during typical operations of traction battery 24 are relatively slow compared to the time at which BECM 50 is to measure the power capability of the traction battery. As such, the temperature and SOC changes do not affect the values of the ECM parameters such as R₀ and R₁ used in the power capability estimation equations (equations 2, 3, and 4 above). However, in a low temperature environment, the variations of the parameters with battery current can cause the results of the power capability equations to be significantly different than the actual power capability as the values of the parameters that are learned during the EKF learning process use battery current that is different than the battery current used to calculate the power capability.

This difference between the estimated and actual power capability results can be understood with reference to FIGS. 5A and 5B. In the low temperature environment, with the battery working current I₁ (instant or filtered value from past collections of battery current, e.g., moving average of past battery current) at a present time, the parameters outputted by the EKF are R₀(I₁) and R₁(I₁); with the battery working current becoming I₂ at a next time, the parameters outputted by EKF are R₀(I₂) and R₁(I₂); with the battery working current becoming I₃ at a next later time, the parameters outputted by the EKF are R₀(I₃) and R₁(I₃); etc. As shown in FIGS. 5A and 5B, in a low temperature environment, the parameters are all different with the value at the point where the power capability is estimated (i.e., at I=I_{Limit}).

The parameters being different in the low temperature environment at the point where the power capability is estimated contributes to two issues. The first issue is that the estimated power capability using the power capability equations may be underestimated in higher SOC ranges. This is because per the R₀ and R₁ relationships with battery current, shown in FIG. 5B, the R₀ and R₁ values are lower at the battery current I_{Limit} than the EKF input current which is considered the battery working current when the power capability is estimated. As such, the estimated battery power capability may be less than the actual battery power capability.

The second issue is that the estimated power capability using the power capability equations may be overestimated in the lower SOC range. This is because per the R₀ and R₁ relationships with battery current, shown in FIG. 5A, the R₀ and R₁ values are higher at the battery current I_{Limit} than the EKF input current which is considered the battery working current when the power capability is estimated. As such, the estimated battery power capability may be greater than the actual battery power capability.

As indicated, conventional power capability estimation methods do not consider the variation of ECM parameters with battery current, which variation occurs in low temperature environment. As the input current of the EKF in the ECM parameter learning process is often different with limited battery current used in the battery power estimation, the difference in the current levels relative to one another will affect the values of the ECM parameters used in the battery power capability estimation. Not considering the variation of the parameters with battery current may cause battery power capability estimation error.

In accordance with the present disclosure, BECM 50 is operable to address this issue. In general, BECM 50 addresses this issue by adjusting for the current-dependent variance of the ECM parameters at low temperature environment in detecting battery power capability. As a result of such adjustment, the power capability of traction battery 24 detected by BECM 50 is accurate with the actual (i.e., true) power capability of the traction battery.

The present disclosure provides solutions for two different system implementations. The first solution regards the system implementation that the ECM parameters are directly learned with EKF. The second solution regards the system implementation in which the variation of the ECM parameters with battery current is expressed as a structural function, and the parameters of the structural function are learned with EKF.

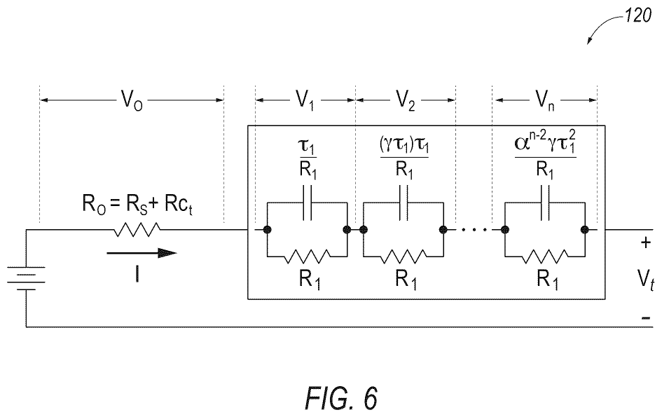

Regarding the system implementation of the second solution, FIG. 6 illustrates a schematic diagram of an ECM 120 of traction battery 24 in the form of a parameter dependent n-RC ECM. ECM 120 is a parameter nRC model with defined current direction where γ=(1/s). Here, SOC and V₁(t) are states, and R₀, R₁, τ₁ are parameters to be learned, via the following equation (7):

$$[ \begin{matrix}\frac{dSOC ( t )}{dt} \\ \frac{{dV}_{1} ( t )}{dt} \\ \frac{{dV}_{2} ( t )}{dt} \\ ⋮ \\ \frac{{dV}_{n} ( t )}{dt} \\ \frac{{dR}_{0} ( t )}{dt} \\ \frac{{dR}_{1} ( t )}{dt} \\ \frac{d {τ}_{1} ( t )}{dt}\end{matrix} ] = [ \begin{matrix}0 & 0 & 0 & 0 & 0 & 0 & 0 & 0 \\ 0 & - \frac{1}{{τ}_{1}} & 0 & 0 & 0 & 0 & 0 & 0 \\ 0 & 0 & - \frac{1}{{τ}_{2}} & 0 & 0 & 0 & 0 & 0 \\ 0 & 0 & 0 & ⋮ & 0 & 0 & 0 & 0 \\ 0 & 0 & 0 & 0 & - \frac{1}{{τ}_{n}} & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ] [ \begin{matrix}SOC \\ {V}_{1} \\ {V}_{2} \\ ⋮ \\ {V}_{n} \\ {R}_{0} \\ {R}_{1} \\ {τ}_{1}\end{matrix} ] + [ \begin{matrix}- \frac{1}{Q} \\ \frac{{R}_{1}}{{τ}_{1}} \\ \frac{{R}_{2}}{{τ}_{2}} \\ ⋮ \\ \frac{{R}_{n}}{{τ}_{n}} \\ 0 \\ 0 \\ 0\end{matrix} ] * I ( t ) + w ( t )$$

$$V ( t ) = OCV ( t ) - {R}_{0} * I ( t ) - {V}_{1} ( t ) - {V}_{2} ( t ) - {V}_{3} ( t ) - … {V}_{n} ( t ) + μ ( t ) \qquad ( 8 a )$$

$$V ( t ) = f ( SOC ( t ) ) - {R}_{0} * I ( t ) - {V}_{1} ( t ) - {V}_{2} ( t ) - {V}_{3} ( t ) - … {V}_{n} ( t ) + μ ( t ) \qquad ( 8 b )$$

Where V₁(t), V₂(t), V₃(t), and Vₙ(t) are functions of R₁ and τ₁, etc. They are calculated via:

$${V}_{i} ( {t}_{k} ) = I ( {t}_{k} ) {R}_{i} ( 1 - {e}^{- \frac{dt}{{τ}_{i}}} ) + {V}_{i} ( {t}_{k - 1} ) \qquad ( 9 )$$

Where dt=tₖ−tₖ₋₁. The state variables in the above functions are learned with EKF. Battery power capability is estimated with the estimated states SOC, V₁, V₂, . . . , Vₙ and parameters R₀, R₁, τ₁.

Per conventional BECM power capability estimation methods for the system implementations of the first and second solutions, the learned parameters output from the EKF are directly used to estimate the power capability, and the battery current for power capability estimation calculation is defined as follows:

$$i ( t ) = \frac{\begin{matrix}OCV - {V}_{t} - {V}_{1} ( {t}_{0} ) {e}^{- \frac{{t}_{d}}{{τ}_{1} ekf}} - {V}_{2} ( {t}_{0} ) {e}^{- \frac{{t}_{d}}{{τ}_{2}}} - \\ {V}_{3} ( {t}_{0} ) {e}^{- \frac{{t}_{d}}{{τ}_{3}}} ... - {V}_{n} ( {t}_{0} ) {e}^{- \frac{{t}_{d}}{{τ}_{n}}}\end{matrix}}{\begin{matrix}{R}_{0 ekf} + {R}_{1 ekf} ( 1 - {e}^{- \frac{{t}_{d}}{{τ}_{1 ekf}}} ) + \\ {R}_{2} ( 1 - {e}^{- \frac{{t}_{d}}{{τ}_{2}}} ) + … {R}_{n} ( 1 - {e}^{- \frac{{t}_{d}}{{τ}_{n}}} )\end{matrix}} \qquad ( 10 )$$

Vt is the battery terminal voltage. V₁(t₀), V₂(t₀), . . . . Vn(t₀) are voltages shown in ECM 120 of FIG. 6 at the time to or at the moment when the battery power estimation is updated. The estimated current and power is at time t in ta seconds after the current time t₀, t_{d}=t−t₀. τ₂, τ₃, . . . τ₃ are functions of τ₁, and R₂, R₃, . . . . Rₙ are function of R₁ in ECM 120. They can also be independent parameters that need to be learned by EKF.

As the parameters R_{0ekf}, R_{1ekf}, τ_{1ekf} vary with battery current in low temperature, their values at the moment to is based on battery current load before the moment, and the values may be different with the time at which traction battery 24 outputs the maximum power. In accordance with the present disclosure, in the lower temperature at which the ECM parameters vary with battery current, BECM 50 maps the parameters learned from EKF into the battery current levels that the power capability is detected.

This mapping of the values of the learned EKF parameters (R_{0ekf}, R_{1ekf}, τ_{1ekf}), which are learned with a given level of input battery current, to the values of the parameters (R₀, R₁, τ₁) at a level of battery current at which the power capability of the battery is detected, is as follows:
R_{0ekf} (I_{ekfinput}, SOC, T) is mapped to R₀ (Iₗᵢₘᵢₜ, SOC, T);
R_{1ekf} (I_{ekfinput}, SOC, T) is mapped to R₁ (Iₗᵢₘᵢₜ, SOC, T); and
τ_{1ekf} (I_{ekfinput}, SOC, T) is mapped to τ₁ (Iₗᵢₘᵢₜ, SOC, T).

The mapping may be implemented using pre-established information such as graphs 100 and 110 of FIGS. 5A and 5B. As there is a practical limit to the amount of such information available, the mapping may further rely on extrapolation using the information available.

The t_{d}=t−t₀ seconds power capability after current time to is shown below.

### Discharging Power Capability

The maximum discharge current that is limited by traction battery minimum voltage (Vₜₘᵢₙ) is defined via the following equation (11):

$${i}_{max} = \frac{\begin{matrix}OCV - {V}_{tmin} - {V}_{1} ( {t}_{0} ) {e}^{- \frac{{t}_{d}}{{τ}_{1} ( {I}_{limit} )}} - {V}_{2} ( {t}_{0} ) {e}^{- \frac{{t}_{d}}{{τ}_{2} ( {I}_{limit} )}} - \\ {V}_{3} ( {t}_{0} ) {e}^{- \frac{{t}_{d}}{{τ}_{3} ( {I}_{limit} )}} ... - {V}_{n} ( {t}_{0} ) {e}^{- \frac{{t}_{d}}{{τ}_{n} ( {I}_{limit} )}}\end{matrix}}{\begin{matrix}{R}_{0} ( {I}_{limit} ) + {R}_{1} ( {I}_{limit} ) ( 1 - {e}^{- \frac{{t}_{d}}{{τ}_{1} ( {I}_{limit} )}} ) + \\ {R}_{2} ( {I}_{limit} ) ( 1 - {e}^{- \frac{{t}_{d}}{{τ}_{2} ( {I}_{limit} )}} ) + … {R}_{n} ( {I}_{limit} ) ( 1 - {e}^{- \frac{{t}_{d}}{{τ}_{n} ( {I}_{limit} )}} )\end{matrix}}$$

Where Iₗᵢₘᵢₜ used in above equation (11) should be Iₗᵢₘᵢₜ≈iₘₐₓ.

The voltage under the battery allowed maximum discharge current (i_{dis,limit}) is defined as follows:

$${V}_{t} dis = OCV - [ {V}_{1} ( {t}_{0} ) {e}^{- \frac{{t}_{d}}{{τ}_{1} ( {I}_{limit} )}} + {V}_{2} ( {t}_{0} ) {e}^{- \frac{{t}_{d}}{{τ}_{2} ( {I}_{limit} )}} + {V}_{3} ( {t}_{0} ) {e}^{- \frac{{t}_{d}}{{τ}_{3} ( {I}_{limit} )}} ... + {V}_{n} ( {t}_{0} ) {e}^{- \frac{{t}_{d}}{{τ}_{n} ( {I}_{limit} )}} ] - {i}_{dis , limit} * [ {R}_{0} ( {I}_{limit} ) + {R}_{1} ( {I}_{limit} ) ( 1 - {e}^{- \frac{{t}_{d}}{{τ}_{1 ( {I}_{limit} )}}} ) + {R}_{2} ( {I}_{limit} ) ( 1 - {e}^{- \frac{{t}_{d}}{{τ}_{2} ( {I}_{limit} )}} ) + … {R}_{n} ( {I}_{limit} ) ( 1 - {e}^{- \frac{{t}_{d}}{{τ}_{n ( {I}_{limit} )}}} ) ] \qquad ( 12 )$$

Where Iₗᵢₘᵢₜ should be i_{dis,limit}.

The discharge power capability at time t_{d}=t−t₀ seconds after the current time is defined as:

$${P}_{{cap}_{dis}} ( t ) = γ \{ \begin{matrix}{i}_{max * {V}_{min}} & if {i}_{max < {i}_{dis} , limit} \\ {i}_{dis , limit} * {V}_{t} dis & Otherwise\end{matrix} \qquad ( 13 )$$

A margin coefficient γ may be used in the final battery power limit calculation and γ≤1 and its value can be changed with temperature and/or SOC.

### Charging Power Capability

Assuming the charge current is negative, the maximum charge current will be the minimum current (i_min) and is defined via the following equation (14):

$${i}_{min} = \frac{\begin{matrix}OCV - {V}_{tmax} - {V}_{1} ( {t}_{0} ) {e}^{- \frac{{t}_{d}}{{τ}_{1} ( {I}_{limit} )}} - {V}_{2} ( {t}_{0} ) {e}^{- \frac{{t}_{d}}{{τ}_{2} ( {I}_{limit} )}} - \\ {V}_{3} ( {t}_{0} ) {e}^{- \frac{{t}_{d}}{{τ}_{3} ( {I}_{limit} )}} ... - {V}_{n} ( {t}_{0} ) {e}^{- \frac{{t}_{d}}{{τ}_{n} ( {I}_{limit} )}}\end{matrix}}{\begin{matrix}{R}_{0} ( {I}_{limit} ) + {R}_{1} ( {I}_{limit} ) ( 1 - {e}^{- \frac{{t}_{d}}{{τ}_{1} ( {I}_{limit} )}} ) + \\ {R}_{2} ( {I}_{limit} ) ( 1 - {e}^{- \frac{{t}_{d}}{{τ}_{2} ( {I}_{limit} )}} ) + … {R}_{n} ( {I}_{limit} ) ( 1 - {e}^{- \frac{{t}_{d}}{{τ}_{n} ( {I}_{limit} )}} )\end{matrix}}$$

Where Iₗᵢₘᵢₜ used in above equation (14) should be Iₗᵢₘᵢₜ≈iₘᵢₙ and Vₜₘₐₓ is battery maximum voltage limit.

The voltage under the maximum charge current (i_{ch,limit}) is defined as follows:

$${V}_{t} ch = OCV - [ {V}_{1} ( {t}_{0} ) {e}^{- \frac{{t}_{d}}{{τ}_{1} ( {I}_{limit} )}} + {V}_{2} ( {t}_{0} ) {e}^{- \frac{{t}_{d}}{{τ}_{2} ( {I}_{limit} )}} + {V}_{3} ( {t}_{0} ) {e}^{\frac{{t}_{d}}{{τ}_{3} ( {I}_{limit} )}} ... + {V}_{n} ( {t}_{0} ) {e}^{- \frac{{t}_{d}}{{τ}_{n} ( {I}_{limit} )}} ] - {i}_{ch , limit} * [ {R}_{0} ( {I}_{limit} ) + {R}_{1} ( {I}_{limit} ) ( 1 - {e}^{- \frac{{t}_{d}}{{τ}_{1 ( {I}_{limit} )}}} ) + {R}_{2} ( {I}_{limit} ) ( 1 - {e}^{- \frac{{t}_{d}}{{τ}_{2} ( {I}_{limit} )}} ) + … {R}_{n} ( {I}_{limit} ) ( 1 - {e}^{- \frac{{t}_{d}}{{τ}_{n ( {I}_{limit} )}}} ) ] \qquad ( 15 )$$

Where Iₗᵢₘᵢₜ used in above equation (15) should be equal ich, limit.

The charge power capability at time after t_{d}=t−t₀ seconds of the current time to is defined as:

$${P}_{{cap}_{ch}} ( t ) = γ \{ \begin{matrix}abs ( {i}_{i \_ min} ) * {V}_{tmax} & if abs ( i\_min ) < {i}_{ch , limit} \\ {i}_{ch , limit} * {V}_{t} ch & Otherwise\end{matrix} \qquad ( 16 )$$

Where i_{ch,limit} is the battery allowed maximum charge current.

Again, the margin coefficient γ may be used in the final battery power limit calculation. Further, the value of γ can be different in charge and discharge.

In summary, in the system implementation of the second solution, the parameters R₀ and R₁ are expressed as structural functions such as such as R0=f(a1, a2, . . . . I), and R1=g(b1, b2, b3, I). Here functions f( ) and g( ) are structural functions. The parameters a1, a2, b1, b2, b3 are structural function parameters which do not vary with battery current I. In the EKF learning, the EKF learns the parameters a1, a2, b1, b2, b3. After the values of these parameters are learned, parameters R₀ and R₁ are calculated by using structural functions f( ) and g( ).

### Solution Implementation in the First System

For the first system, the ECM parameters are expressed as a 3D (three-dimensional) table. One implementation example is described as follows. Initially, BECM 50 stores pre-calibrated 3D parameter tables for all independent ECM parameters that are to be used for calculating the power capability, such as R_{0_table} (I, SOC, T) and R_{1_table} (I, SOC, T). When a parameter is dependent on another independent parameter, its table is not needed, e.g., R₂, R₃, . . . . Rₙ of ECM 120 of FIG. 6. Averages of the absolute current, SOC, and temperature are detected by BECM 50 in a length of time just prior to the time to when the power capability is updated. The length of time depends on the EKF learning speed, e.g., the length of time is about one to three times longer than the time the EKF uses to learn the parameters. Using the average values abs(I)ₐᵥₑ, SOCₐᵥₑ, and Tₐᵥₑ, BECM 50 estimates the values of the independent ECM parameters, such as R₀ and R₁ in the 3D table, that correspond to the average values, e.g., R_{0_table} (abs(I)ₐᵥₑ, SOCₐᵥₑ, Tₐᵥₑ), and R_{1_table} (abs(I)ₐᵥₑ, SOCₐᵥₑ, Tₐᵥₑ).

In turn, BECM 50 obtains the mapping matrixes:

$${R}_{0 \_ map \_ matrix} ( I , {SOC}_{ave} , {T}_{ave} ) = {R}_{0 \_ table} ( I , SOC , T ) / {R}_{0 \_ table} ( {abs ( I )}_{ave} , {SOC}_{ave} , {T}_{ave} )$$

$${R}_{1 \_ map \_ matrix} ( I , {SOC}_{ave} , {T}_{ave} ) = {R}_{1 \_ table} ( I , SOC , T ) / {R}_{1 \_ table} ( {abs ( I )}_{ave} , {SOC}_{ave} , {T}_{ave} )$$

In the discharge case, BECM 50 maps the parameters learned from EKF at the current level of the discharge current i_{dis,limit} such as:

$${R}_{0} = {R}_{0 \_ map \_ matrix} ( {i}_{dis , limit} , SOC , T ) * {R}_{0 \_ EKF}$$

$${R}_{1} = {R}_{1 \_ map \_ matrix} ( {i}_{dis , limit} , SOC , T ) * {R}_{1 \_ EKF}$$

The other parameters, such as R₂, R₃, . . . . Rₙ, that are dependent on R₀, R₁, and τ₁ are also calculated based on their dependent relationship.

Then, BECM 50 calculates the voltage under the limited discharge current i_{dis,limit}, at the moment when power capability is estimated, as follows:

$${V}_{t} dis ( t ) = OCV - [ {V}_{1} ( {t}_{0} ) {e}^{- \frac{{t}_{d}}{{τ}_{1}}} + {V}_{2} ( {t}_{0} ) {e}^{- \frac{{t}_{d}}{{τ}_{2}}} + {V}_{3} ( {t}_{o} ) {e}^{- \frac{{t}_{d}}{{τ}_{3}}} ... + {V}_{n} ( {t}_{0} ) {e}^{- \frac{{t}_{d}}{{τ}_{n}}} ] - {i}_{dis , limit} [ {R}_{0} + {R}_{1} ( 1 - {e}^{- \frac{{t}_{d}}{{τ}_{1}}} ) + {R}_{2} ( 1 - {e}^{- \frac{{t}_{d}}{{τ}_{2}}} ) + … {R}_{n} ( 1 - {e}^{- \frac{{t}_{d}}{{τ}_{n}}} ) ] \qquad ( 17 )$$

If Vₜdis(t)≥Vₘᵢₙ, then BECM 50 calculates the power capability as follows:

$${P}_{{cap}_{dis}} ( t ) = γ * {i}_{dis , limit} * {V}_{t} dis ( t ) \qquad ( 18 )$$

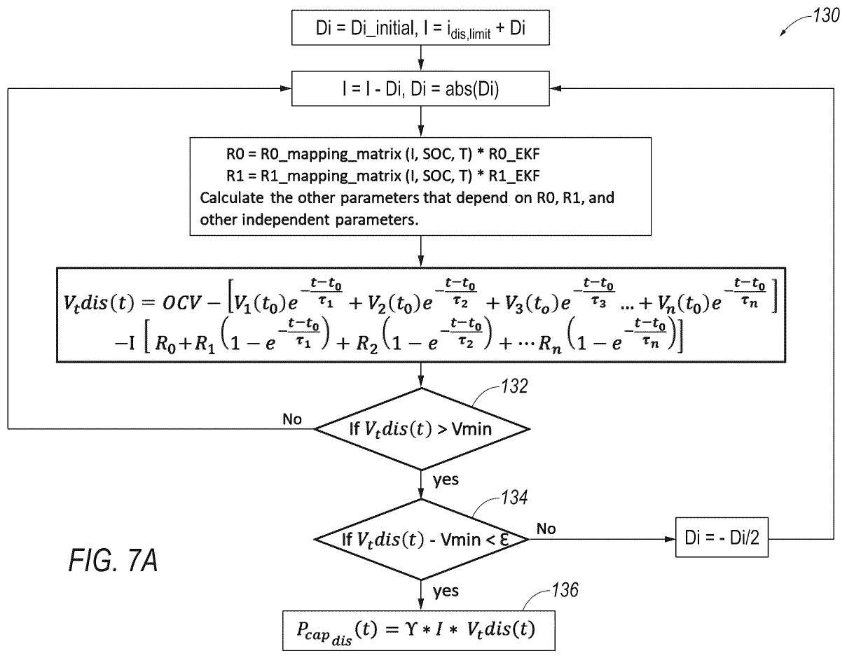

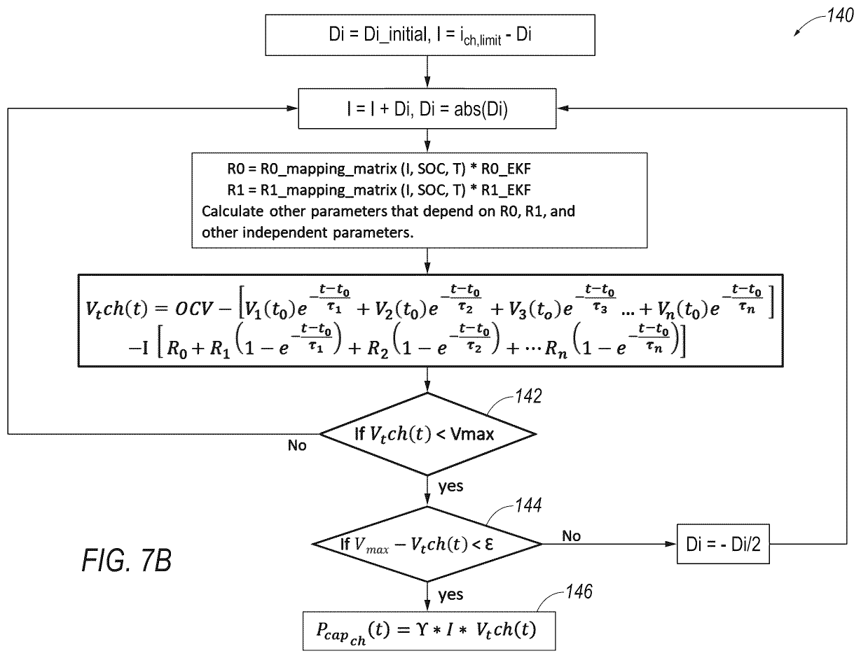

Otherwise, if equation (17) calculated voltage Vₜdis(t)<Vₘᵢₙ, FIG. 7A illustrates a flowchart 130 of the above-described calculations carried out by BECM 50 in detecting the discharge power capability of traction battery 24. The variable D_{i_initial} shown in FIG. 7A is a small positive number, such as

$${D}_{i \_ initial} = \frac{( {i}_{dis , limit} )}{10} .$$

While Vₜdis(t)≤Vₘᵢₙ per decision block 132, the calculations are repeated until Vₜdis(t)≥Vₘᵢₙ. Subsequently, until Vₜdis(t) is sufficiently larger than Vₘᵢₙ per decision block 134, the calculations are further repeated with a smaller variable D_{i_initial} until Vₜdis(t) is sufficiently close to Vₘᵢₙ at which time the power capability is calculated per process block 136.

In the charge case, BECM 50 maps the parameters learned from EKF at the current level of the charge current ich, limit such as:

$${R}_{0} = {R}_{0 \_ mapping \_ matrix} ( {i}_{ch , limit} , SOC , T ) * {R}_{0 \_ EKF}$$

$${R}_{1} = {R}_{1 \_ mapping \_ matrix} ( {i}_{ch , limit} , SOC , T ) * {R}_{1 \_ EKF}$$

The other parameters, such as R₂, R₃, . . . . Rₙ, that depend on R₀, R₁, and τ₁ are also calculated based on their dependent relationship.

Then, BECM 50 calculates the voltage under the limited charge current i_{ch,limit}, at the moment when power capability is estimated, as follows:

$${V}_{t} ch ( t ) = OCV - [ {V}_{1} ( {t}_{0} ) {e}^{- \frac{{t}_{d}}{{τ}_{1}}} + {V}_{2} ( {t}_{0} ) {e}^{- \frac{{t}_{d}}{{τ}_{2}}} + {V}_{3} ( {t}_{o} ) {e}^{- \frac{{t}_{d}}{{τ}_{3}}} ... + {V}_{n} ( {t}_{0} ) {e}^{- \frac{{t}_{d}}{{τ}_{n}}} ] - {i}_{ch , limit} [ {R}_{0} + {R}_{1} ( 1 - {e}^{- \frac{{t}_{d}}{{τ}_{1}}} ) + {R}_{2} ( 1 - {e}^{- \frac{{t}_{d}}{{τ}_{2}}} ) + … {R}_{n} ( 1 - {e}^{- \frac{{t}_{d}}{{τ}_{n}}} ) ] \qquad ( 19 )$$

If the Vₜdis(t)≤Vₘₐₓ, then BECM 50 calculates the power capability as follows:

$${P}_{{cap}_{ch}} ( t ) = γ * {i}_{ch , limit} * {V}_{t} ch ( t ) \qquad ( 20 )$$

Otherwise, if equation (19) calculated voltage Vₜdis(t)>Vₘₐₓ, FIG. 7B illustrates a flowchart 140 of the above-described calculations carried out by BECM 50 in detecting the charge power capability of traction battery 24. While Vₜch(t)≥Vₘₐₓ per decision block 142, the calculations are repeated until Vₜch(t)<Vₘₐₓ. Subsequently, until Vₜch(t) is sufficiently smaller than Vₘₐₓ per decision block 144, the calculations are further repeated with a smaller variable D_{i_initial} until Vₜch(t) is sufficiently close to Vₘₐₓ at which time the power capability is calculated per process block 146.

In higher temperatures, such as equal or above room temperature, the ECM parameters do not vary significantly with current. Therefore, the parameters learned from EKF, such as R_{0ekf}, R_{0ekf}, and τ_{1ekf}, can be used directly to estimate the battery power and no mapping is needed.

### Solution Implementation in the Second System

With reference to ECM 120 of FIG. 6 in which the variation of certain ECM parameters with current is expressed as a structural function, the EKF is used to learn the parameters of the structural function. In this case, the structural function and the learned EKF parameters are used to calculate the ECM parameters at the battery current levels that the power capability is detected.

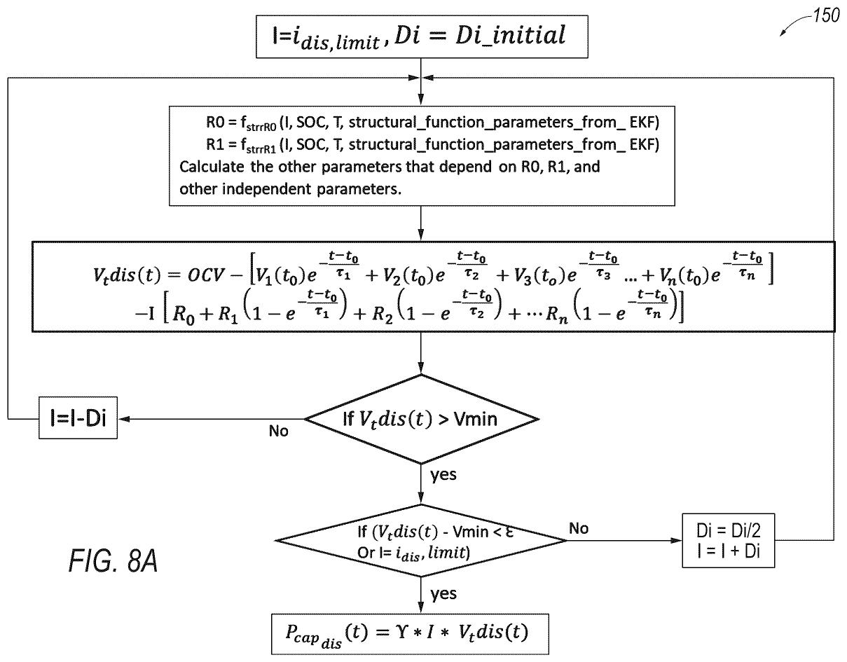

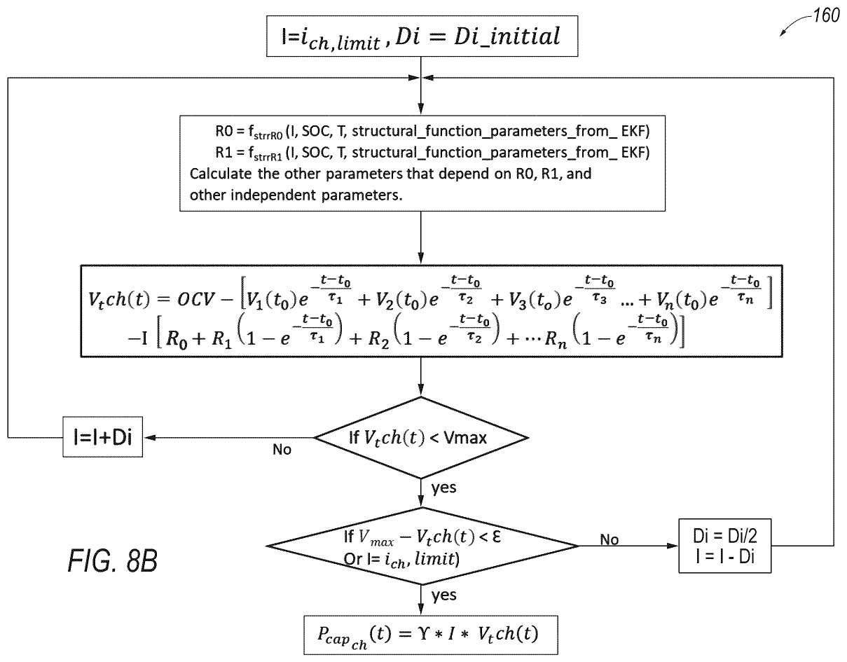

FIG. 8A illustrates a flowchart 150 of calculations carried out by BECM 50 in detecting the discharge power capability of traction battery 24 pursuant to the second solution implementation. FIG. 8B illustrates a flowchart 160 of calculations carried out by the BECM in detecting the charge power capability of traction battery 24 pursuant to the second solution implementation.

As set forth, in accordance with the present disclosure, BECM 50 is operable to adjust for current-dependent variance of ECM parameters at low temperature environment in detecting the power capability of traction battery 24. As such, in battery power capability calculations, BECM 50 considers the ECM parameter variation with battery current. BECM 50 implements this consideration by mapping the ECM parameters learned from EKF into the corresponding battery current levels of battery power capability calculation. In this way, BECM 50 executes a mapping method for mapping ECM parameters that are directly learned with EKF to other battery current levels. The mapping method may be used for mapping ECM parameters that are calculated with a structural function.

As described, a main topic of the present disclosure concerns the battery current used to calculate the power capability of the traction battery is different than the battery current that is used to learn the values of the parameters of the ECM. That is, at a given time, when the traction battery has battery current flow, the learned ECM parameter values are based on the battery current flow whereas the battery current that is used to calculate the power capability is different than the battery current flow. The values of the ECM parameters, such as the resistor parameters R₀ and R₁, corresponding to the two different currents (i.e., (i) the battery current flow and (ii) the battery current that is used to calculate the power capability) are different. Therefore, the values of the resistor parameters that are learned via the battery current flow are mapped into the values of the resistor parameters that would be learned via the battery current that is used to calculate the power capability.

While exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure. Additionally, the features of various implementing embodiments may be combined to form further embodiments of the present disclosure.

What is claimed is:

1. A system comprising:
a battery; and
a controller configured to charge and/or discharge the battery based on a power capability of the battery defined by a value of a parameter of a model of the battery mapped from a value of the parameter that is learned with a battery current of the battery different from a battery current used in calculating the power capability.

2. The system of claim 1 wherein:
the parameter varies with battery current whereby, as the battery current of the battery is different from the battery current used in calculating the power capability, the learned value of the parameter is different than a value of the parameter that would be learned with the battery current used in calculating the power capability.

3. The system of claim 1 wherein:
the mapped value of the parameter is a value of the parameter that would be learned with the battery current of the battery being the battery current used in calculating the power capability.

4. The system of claim 1 wherein:
the controller is further configured to map the mapped value of the parameter from the learned value of the parameter when the battery is in an environment at which the parameter varies with battery current.

5. The system of claim 1 wherein:
the controller is further configured to map the mapped value of the parameter from the learned value of the parameter when a temperature of the battery is less than a predetermined temperature threshold.

6. The system of claim 1 wherein:
the battery current of the battery is lower in magnitude than the battery current used in calculating the power capability.

7. The system of claim 1 wherein:
the model is an equivalent circuit model (ECM) and the parameter is a resistor of the ECM.

8. The system of claim 7 wherein:
the resistor is either a resistor R₀ or a resistor R₁.

9. The system of claim 2 wherein:
variation of the parameter with battery current is expressed as a structural function.

10. The system of claim 9 wherein:
the controller is further configured to detect the power capability of the battery based on the mapped value of the parameter that is mapped from a learned value of a parameter of the structural function.

11. The system of claim 1 wherein:
the learned value of the parameter is learned using a Kalman filter with the battery current of the battery.

12. A method comprising:
learning a value of a parameter of a model of a battery with a battery current of the battery, the battery current of the battery being different from a battery current used in calculating a power capability of the battery;
mapping the learned value of the parameter to a value of the parameter that would be learned with the battery current used in calculating the power capability; and
charging and/or discharging the battery based on a power capability of the battery defined by the mapped value of the parameter.

13. The method of claim 12 further comprising:
learning a value of a second parameter of the model of the battery with the battery current of the battery;
mapping the learned value of the second parameter to a value of the second parameter that would be learned with the battery current used in calculating the power capability; and
charging and/or discharging the battery based on a power capability of the battery defined by the mapped values of the parameters.

14. The method of claim 13 wherein:
the parameters are resistor parameters.

15. An electrified vehicle comprising:
a traction battery; and
a controller configured to learn a value of a parameter of a model of the traction battery with a battery current of the traction battery, wherein the parameter varies with battery current; and
the controller further configured to control the traction battery and/or another component of the electrified vehicle based on a power capability of the traction battery defined by a value of the parameter that is mapped from the learned value.

16. The electrified vehicle of claim 15 wherein:
the mapped value of the parameter is a value of the power that the controller would have learned with a battery current used in calculating a power capability of the traction battery, the battery current used in calculating the power capability of the traction battery being different than the battery current of the traction battery.

17. The electrified vehicle of claim 15 wherein:
the model is an equivalent circuit model (ECM) and the parameter is a resistor of the ECM.

18. The electrified vehicle of claim 15 wherein:
variation of the parameter with battery current is expressed as a structural function.

19. The electrified vehicle of claim 18 wherein:
the controller is further configured to detect the power capability of the battery based on the mapped value of the parameter that is mapped from a learned value of a parameter of the structural function.

20. The electrified vehicle of claim 15 wherein:
the controller is further configured to learn the learned value of the parameter using a Kalman filter with the battery current of the battery.
